(19) United States
(12) Patent Application Publication
(10) Pub. No.: US 2005/0153644 A1
(43) Pub. Date: Jul. 14, 2005

(54) Instrument and method for preparing plug-cut bait

(76) Inventor: Kenichi K. Yabusaki, Albany, CA (US)

Correspondence Address: HOWARD E LEBOWITZ, 19682 HESPERIAN BLVD, Suite 208, HAYWARD, CA, 94541, US

(21) Appl. No.: 10/751,181

(22) Filed: Dec. 31, 2003

(51) Int. Cl. A22B 5/18

(52) U.S. Cl. 452/117

(57) ABSTRACT

One aspect of the invention is a entrails removal instrument for making a hollow cavity in the gut of a bait fish such as a herring, including: an elongate body having two straight parallel longitudinal sides, said body forming a curved groove between said longitudinal sides; an end section, said end section extending from said elongate body and tapering in width to a rounded point; and a plurality of tines emanating from a surface of the instrument, wherein at least one tine of said plurality of tines emanates from the end section and is directed away from the rounded point and towards the elongate body, wherein said entrails removal instrument is adapted to fit into the body of the bait fish and form a hollow cavity when inserted into the body, rotated and removed.

### BACKGROUND OF THE INVENTION

1. Field of the Invention

The invention pertains to an instrument and method for eviscerating a bait fish to form a plug-cut bait preferably a plug-cut herring.

2. Description of the Prior Art

A preferred bait used in catching Pacific salmon species, such as Chinook, Coho, Chum or Pink is the “plug-cut herring”. A plug-cut herring is the remainder of a fresh or thawed frozen herring after the head is removed, preferably in a bevel cut. The angle and style of cut are well known to fisherpersons and the head may be sliced off with a knife or with special devices manufactured for that purpose. Many fisherpersons prefer to also remove the internal organs of the fish known as entrails or viscera from the fish gut so as to form a hollow cavity within the body of the fish. By proper placement of fishing hooks, attached to a fishing line, into the body of the plug-cut herring through the hollow cavity, an effective bait is produced.

The reason for the desirability of this bait is that the angle of the cut, and the hydrodynamic flow through the hollow gut cavity in concert with proper placement of one or more fishhooks causes the bait to spin when pulled by a fishing line.

A current method of removing entrails from a plug-cut herring is inserting a sharp knife blade into the gut of the plug-cut herring and carefully rotating the knife blade to sever the entrails that are then carefully removed. An alternative method is to stick a portion of entrails with the point of a knife and then pull out that portion. The method is repeated until a hollow cavity is formed. Both of these methods are tedious and often ruin the bait fish by inadvertent sticking of the instrument through the body of the fish, and thus compromising the hydrodynamic action of the plug-cut bait.

There are a number of prior tools for removing viscera from fish, however these are more suited to preparing the fish for consumption as opposed to preparing plug-cut bait. Some of these tools are disclosed in U.S. Pat. Nos. 6,477,803, 5,145,452, 4,528,751, and 4,461,080.

There is a need for an entrails or viscera removal instrument that can readily eviscerate a herring bait fish to form a plug-cut herring bait.

There is a further need for an entrails or viscera removal instrument for eviscerating other bait fish to form plug-cut bait.

### SUMMARY OF THE INVENTION

It is an object of the invention to provide an improved instrument suitable for readily eviscerating a herring to form a plug-cut herring bait, and that would also be useful for eviscerating other bait fish.

It is a further object to provide a method of preparing plug-cut bait.

It is a still further object of the invention to provide an improved plug-cut bait made according to the method.

A preferred bait in catching Pacific salmon species, such as Chinook, Coho, Chum or Pink is the “plug-cut herring”. A plug-cut herring is the remainder of a fresh or thawed frozen herring after the head is removed, preferably in a bevel cut. The angle and style of cut are well known to fisherpersons and the head may be sliced off with a knife or with special devices manufactured for that purpose. Many fisherpersons prefer to also remove the internal organs of the fish known as entrails or viscera from the fish gut so as to form a hollow cavity within the body of the fish. The invention pertains to this step of producing a hollow cavity by removing the entrails. Bait is formed by placing one or more fishing hooks attached to a fishing line through the hollow cavity and out through the body of the herring in a manner that gives the desired action when pulled through the water. Plug-cut bait can also be made from other fish such as anchovy, sardine, or smelt.

The reason for the desirability of this bait is that the angle of the cut, and the hydrodynamic flow through the hollow gut cavity in concert with proper placement of one or more fishhooks causes the bait to spin when pulled by a fishing line.

One aspect of the invention is an entrails removal instrument for making a hollow cavity in the gut of a bait fish such as a herring, including:
a. an elongate body having two straight parallel longitudinal sides, said body forming a curved groove between said longitudinal sides;
b. an end section, said end section extending from said elongate body and tapering in width to a rounded point; and
c. a plurality of tines emanating from a surface of the instrument, wherein at least one tine of said plurality of tines emanates from the end section and is directed away from the rounded point and towards the elongate body, wherein said entrails removal instrument is adapted to fit into the body of the bait fish and form a hollow cavity when inserted into the body, rotated and removed.

Another aspect of the invention is a method of making a plug-cut bait from a bait fish having a head, body, and tail, the method including acts of:
a. cutting the head off the bait fish with a knife while leaving the fish body and tail intact;
b. inserting an entrails removal instrument into the fish body to a position forward of the tail, wherein said entrails removal instrument comprises an elongate instrument body having two straight parallel longitudinal sides, said instrument body forming a curved groove between said longitudinal sides; an end section, said end section extending from said instrument body and tapering to a rounded point; and a plurality of tines emanating from a surface of the instrument, wherein at least one tine of said plurality of tines emanates from the end section and is directed away from the rounded point and towards the elongate body, wherein said entrails removal instrument is adapted to fit into the body of the bait fish and form a hollow cavity when inserted into the body, rotated and removed;
c. rotating said entrails removal instrument; and
d. removing the entrails removal instrument with a pulling motion, whereby a the viscera of the fish are removed leaving the body and tail intact and without puncture with a neat hollow cavity.

Still another aspect of the invention is an improved plug-cut bait made according to the method. A bait made according to the method is improved because of the smooth and regular cut of the cavity made by the entrails removal instrument, and absence of punctures through the body.

### BRIEF DESCRIPTION OF THE DRAWINGS

These and other features, aspects and advantages of the present invention will become better understood with regard to the following description, appended claims and accompanying drawings, where:

FIG. 1 is a perspective drawing of a preferred entrails removal instrument.

FIGS. 2A to 2D are a sequence of fanciful sketches illustrating the method of making a plug-cut bait, and a plug-cut herring according to the invention.

### DESCRIPTION OF THE PREFERRED EMBODIMENTS

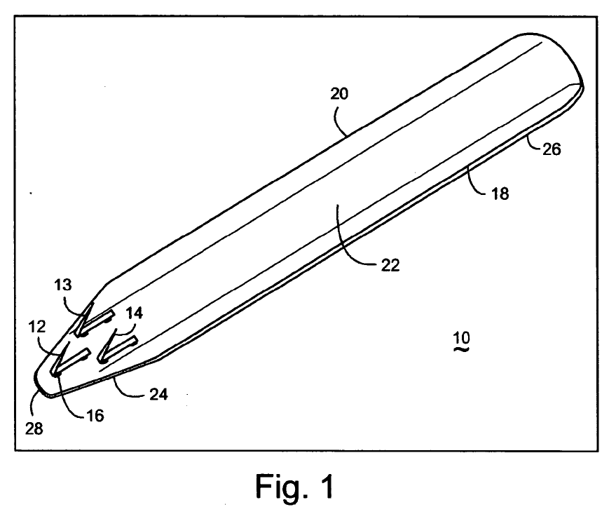

One preferred embodiment of the invention is shown in FIG. 1. An entrails removal instrument 10 is illustrated. The instrument includes an elongate body 26, an end section 24 and a plurality of tines 12, 13, and 14 emanating from the end section of the instrument. It is not necessary that all of the tines emanate from the end section, some may emanate from the portion of the body adjacent to the end section.

The elongate body 26 includes two straight parallel longitudinal sides 18 and 20, and forms a curved groove 22 between the longitudinal sides.

The end section 24 tapers to a rounded tip 28 at the end thereof and is preferably sharpened to a knife-edge. At least one tine 12 emanates from the end section at attachment point 16. The instrument contains a plurality of tines, including the at least one tine emanating from the end section, which may emanate from either the end section or the portion of the elongate body adjacent to the end section. There are preferably a total of three or four tines.

The instrument including the elongate body and end section preferably has a length of at least about 5 inches and preferably about 6 inches long where the end section is preferably at least about 1 inch long. The width measured between the two longitudinal sides is preferably between about 1/2 inch and 1 ½ inches, more preferably about ¾ inch wide. The depth of the groove is preferably between about 1/2 inch and 1 1/2 inches, more preferably about 3/4 inch deep. The preferred material is stainless steel, though steel is acceptable, preferably a hardened steel. Another alternative is to make the entire instrument from hard plastic, preferably by injection molding. In this case the elongate body, end section and tines are one integral piece.

The tines are preferably between about 1/4 inch and 1 inch long and preferably inclined at an angle of at least about 15 degrees from a surface to which the tine emanates or is attached, preferably about 15 degrees to about 45 degrees, more preferably about 30 degrees. The tines may be integrally formed as part of the end and body or attached.

The tines may have a small hook ending or preferably be straight prongs ending in a sharp point.

The elongate body and the end section are preferably one integral piece, though it is certainly possible to fashion them separately and attach them together.

In a preferred embodiment, a laboratory device known as a scoopula, such as the six inch stainless steel Fisherbrand™ Scoopula Spatula shown in the 2003 Fisher Scientific catalogue as number 14-357 is used as the starting material for making the instrument. The pointed end is sharpened to a knife blade and three straight tines are welded to the Scoopula at about a 30° angle to the horizontal in the tapered area of the tip. This embodiment works well for herring bait fish. Another alternative embodiment is an instrument fabricated by a metal stamping process from stainless steel, steel, or another metal. In this alternative, the entire instrument is preferably a single integral piece.

Other arrangements may be constructed in different sizes for different fish by very conventional methods, well known to those skilled in the art.

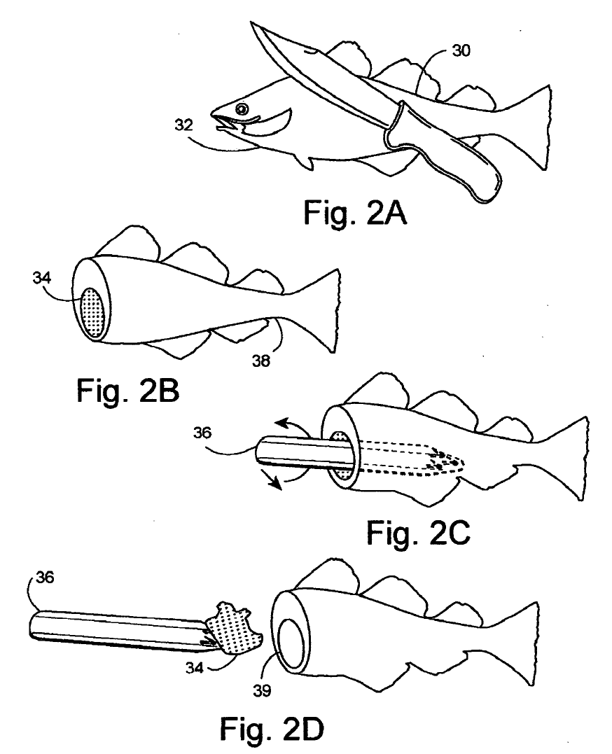

Another aspect of the invention, is a method for using an entrails removal instrument to produce a plug-cut bait, preferably a plug-cut herring . A method of producing a plug-cut herring is illustrated in FIGS. 2A to 2D. First a conventional knife or special purpose tool is used to remove the head 32, revealing the entrails 34 in the body and tail 38 (FIGS. 2A and 2B). Then insert the entrails removal tool 36 rounded tip first several inches into the fish and engage the entails with the tines of the instrument. Then rotate the tool, preferably at least one complete revolution, while moving the instrument laterally as shown in FIG. 2C, producing a hollow cavity 39 preferably between about 3/4 inch and about 1 1/2 inches wide and between about 2 inches and 4 inches deep when the instrument 36 is withdrawn with the entrails 34. To finish preparation of the bait one or more fishing hooks attached to a line are placed in the fish in a manner to facilitate proper rotation of the bait. The placement of hooks and use of the bait is conventional for plug-cut bait, and is well known to fisherpersons and others skilled in the art.

Another aspect of the invention is an improved bait shown in FIG. 2D with excellent hydrodynamic properties due to the clean hollow cavity without punctures.

It can be seen that the invention is an improved instrument suitable for readily eviscerating a herring to form a plug-cut herring bait, and provides an improved method of producing a plug-cut herring bait and an improved bait.

Although the present invention has been described in considerable detail with reference to certain preferred versions thereof other versions are possible. Therefore the spirit and scope of the appended claims should not be limited to the preferred versions herein.

1. An entrails removal instrument for making a hollow cavity in a body of a bait fish, including:
a. an elongate body having two straight parallel longitudinal sides, said body forming a curved groove between said longitudinal sides;
b. an end section, said end section extending from said elongate body and tapering to a rounded point; and
c. a plurality of tines emanating from a surface of the instrument, wherein at least one tine of said plurality of tines emanates from the end section and is directed away from the rounded point and towards the elongate body, wherein said entrails removal instrument is adapted to fit into the body of the bait fish and form a hollow cavity when the instrument is inserted into the body, rotated and removed.

2. The entrails removal instrument of claim 1, wherein said instrument is made from steel.

3. The entrails removal instrument of claim 1, wherein said instrument is made from stainless steel.

4. The entrails removal instrument of claim 1, wherein the at least one tine that emanates from the end section includes a plurality of tines.

5. The entrails removal instrument of claim 1, wherein the plurality of tines emanate from the surface of the instrument at an angle in the range between about 15 degrees and about 45 degrees.

6. The entrails removal instrument of claim 1, wherein the end section includes a blade surface at the rounded point.

7. The entrails removal instrument of claim 1, wherein the instrument is one integral piece.

8. The entrails removal instrument of claim 1, wherein the bait fish is a herring.

9. A method of making a plug-cut bait from a bait fish having a head, body, and tail, the method including acts of:
a. cutting the head off the bait fish with a knife while leaving the fish body and tail intact;
b. inserting an entrails removal instrument into the fish body to a position forward of the tail, wherein said entrails removal instrument comprises an elongate instrument body having two straight parallel longitudinal sides, said instrument body forming a curved groove between said longitudinal sides; an end section, said end section extending from said instrument body and tapering to a rounded point; and a plurality of tines emanating from a surface of the instrument, wherein at least one tine of said plurality of tines emanates from the end section and is directed away from the rounded point and towards the elongate body, wherein said entrails removal instrument is adapted to fit into the body of the bait fish and form a hollow cavity when inserted into the body, rotated and removed;
c. rotating said entrails removal instrument; and
d. removing the entrails removal instrument, whereby a the viscera of the fish are removed leaving the body and tail intact with a neat hollow cavity.

10. The method of claim 9, wherein the entrails remover is inserted at least 2 inches into the body.

11. The method of claim 9, further including moving the entrails removal instrument in a lateral motion.

12. The method of claim 11, wherein the act of rotating includes rotating at least 360°.

13. The method of claim 12, wherein the method further comprises inserting at least one fishing hook attached to a fishing line into the hollow cavity and pushing it out through the fish body to form a bait.

14. The method of claim 9, wherein the bait fish is herring.

15. The method of claim 13, wherein the at least one fishing hook includes a plurality of fishing hooks.

16. A plug-cut bait made according to the method of claim 12.

17. A plug-cut bait made according to the method of claim 13.

18. A plug-cut bait made according to the method of claim 15.

19. The plug-cut bait of claim 16, wherein the bait fish is chosen from the group consisting of herring, anchovy, sardine and smelt.

20. The plug-cut bait of claim 17, wherein the bait fish is chosen from the group consisting of herring, anchovy, sardine and smelt.

21. The plug-cut bait of claim 18, wherein the bait fish is chosen from the group consisting of herring, anchovy, sardine and smelt.
